(19) United States
(12) Patent Application Publication
(10) Pub. No.: US 2008/0077319 A1
(43) Pub. Date: Mar. 27, 2008

(54) Navigation System Using Intersection Information

(75) Inventors: Manabu Kato, Novi, MI (US); Deepak Ramaswamy, Superior Township, MI (US); Sadanori Horiguchi, Novi, MI (US); Katsuaki Tanaka, West Bloomfield, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi Informatics Corporation, Kanagawa-Ken (JP)

(21) Appl. No.: 11/535,626

(22) Filed: Sep. 27, 2006

(51) Int. Cl. G01C 21/32

(52) U.S. Cl. 701/208; 701/200; 340/995.1

(57) ABSTRACT

A navigation method and system for determining a desired geographic location. An intersection is first inputted by road names after which all intersections within a predetermined geographic area are identified which correspond to the inputted intersection. In the event that the number of identified intersections exceeds a predetermined threshold, additional information is optionally inputted regarding the desired geographic location and thereafter the identified locations are searched to determine the desired geographic location by utilizing the additional information.

### BACKGROUND OF THE INVENTION

I. Field of the Invention

The present invention relates generally to navigation systems and, more particularly, to a navigation system which identifies the desired geographic location by road intersection.

II. Description of Material Art

There are many previously known navigation systems which not only identify and display a desired geographic location, but also compute a route from the current location to the desired location. Many such navigation systems are found on automotive vehicles although such navigation systems are used for other applications.

In some situations, it is desirable to specify the desired geographic location by the intersection of two roads. The proper identification of an intersection by two road names, however, presents a number of difficulties which the previously known navigation systems have not fully addressed.

First, while many people may readily identify the names of the two roads which form the intersection, the prefix, such as “West”, “North”, etc. for that particular intersection is oftentimes unknown. Similarly, the road suffix, such as “Street”, “Avenue”, “Road”, etc. is likewise unknown. Furthermore, unless both the prefix and suffix for the roads which form a particular intersection are known, the navigation system is oftentimes unable to identify the desired intersection or, alternatively, identifies numerous intersections which meet the road intersection criteria specified by the user.

A still further disadvantage of these previously known navigation systems is that, within a particular geographic location, such as a state, there are many intersections corresponding to the specified street names. For example, even within a relatively small geographic area, there are numerous intersections formed by the roads “Main” and “Washington”. Consequently, upon completion of searching its map database, the navigation system for such an intersection having common road names will identify numerous different intersections which correspond to the search criteria.

In the event that the navigation system identifies numerous intersections which correspond to the search criteria specified by the user, while it is possible to provide a list of all of the intersections on a display device to the user, in many situations such a solution is simply impractical. For example, navigation systems of the type used in automotive vehicles have a fairly small screen which limits the number of intersections that can be displayed at any given time on the screen. Furthermore, for safety reasons, it is undesirable to present a long list of intersections, even through a scroll bar window or multiple page display, on an automotive navigation system since such a display of numerous intersections would be simply too distracting for the driver of the vehicle.

### SUMMARY OF THE PRESENT INVENTION

The present invention provides both a method and system for determining a desired geographic location corresponding to a road intersection which overcomes the above-mentioned disadvantages of the previously known methods and systems.

In brief in the system and method of the present invention, an intersection is inputted by road names to the system. Various means, such as voice recognition circuitry, a joystick, keyboard, a keyboard display on a touch screen, or other graphic user interface (GUI) may be used to input the road names for the intersection.

After the road names have been inputted, the method and system then identifies all intersections within a predetermined geographic area which correspond to the inputted intersection. The predetermined geographic area may, for example, comprise a state or a portion of a state, but could comprise the entire United States or North America.

After the roads which form the intersection have been inputted by the user, the method and system then initiates a search using conventional search techniques of a map database for intersections corresponding to the inputted road names. In the event that only a single or very limited number of intersections are found, the intersection or intersections are displayed on a display device for the navigation system.

Conversely, in the event that a number of intersections meeting the search criteria are located during the search of the map database greater than a threshold number, the method and system then enables the user to input additional information designed to identify which of the numerous intersections correspond to the desired geographic location. This additional information may be entered either manually through a GUI or verbally through speech recognition equipment.

For example, the additional information may comprise a municipal name, i.e. city, town, village, etc., in which the intersection is located. Alternatively, a point of interest, telephone area code, postal zip code, a near road name or a road address range may be inputted as additional information in order to identify the desired geographic location.

Once the additional information has been entered, the method and system then searches the map database with the additional information to identify which of the numerous intersections correspond to the additional information and thus represent the desired geographic location. Once identified, the desired geographic location is displayed on the display screen for the navigation system or otherwise presented to the user.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view illustrating a preferred embodiment of the present invention;

FIG. 2 is a view illustrating an exemplary map database structure;

FIG. 3 is an exemplary point of interest map database structure;

FIG. 4 is an exemplary intersection database structure;

FIG. 5 is a flowchart illustrating a preferred embodiment of the present invention;

FIG. 6 is an exemplary screen display illustrating the operation of the present invention;

FIG. 7 is an exemplary screen display illustrating the operation of the present invention;

FIG. 8 is an exemplary screen display illustrating the operation of the present invention;

FIG. 9 is an exemplary screen display illustrating the operation of the present invention;

FIG. 10 is an exemplary screen display illustrating the operation of the present invention;

FIG. 11 is an exemplary screen display illustrating the operation of the present invention; and

FIG. 12 is an exemplary screen display of an identified intersection.

### DETAILED DESCRIPTION OF A PREFERRED EMBODIMENT OF THE PRESENT INVENTION

With reference first to FIG. 1, a block diagrammatic view of a navigation system 10 of the present invention is illustrated. The navigation system 10 includes an input unit 12 which receives a user input 14. The input unit 12 may be a keyboard, keypad on a touch screen, joystick, etc. The input unit 12 may also include voice recognition circuitry to receive verbal input 14 from the user, Alternatively, the input unit 12 may comprise a keyboard displayed on a touch screen or other graphic user interface.

The input unit 12 identifies the user input and provides an output signal to a destination search engine 16. The destination search engine 16 is typically microprocessor based and queries a map database 18 to determine the desired location or destination. The map database 18 may be internal to the system 10, e.g. in memory or persistent memory, or external to the system 10 and accessed by the system 10, e.g. through a wireless communication. Once located, the destination is displayed on a display screen 20 or other output device. The display screen 20 may also form a touch screen in order to provide the user input 12 to the destination search engine 16.

With reference now to FIG. 2, the various data fields of a typical map database are illustrated. As shown in FIG. 2, the database contains a plurality of entries, each having its own index number. The map database further contains a category indicating the type of road, the latitude and longitudinal position of the road as well as the state, county, city and postal zip code for the road. Each entry also includes the name of the road as well as its speed limit.

Still referring to FIG. 2 in addition to the various previously described information concerning each road, the database also includes intersection information. For example, for index number 1 corresponding to I-96 in Novi, Mich., the intersection information contains the index number, in this case 7, which constitutes the intersection information. For the example illustrated in FIG. 2, the index 7 corresponds to I-275 also in Novi, Mich. Consequently, from the exemplary map database illustrated in FIG. 2, I-96 forms an intersection with I-275 in Novi, Mich.

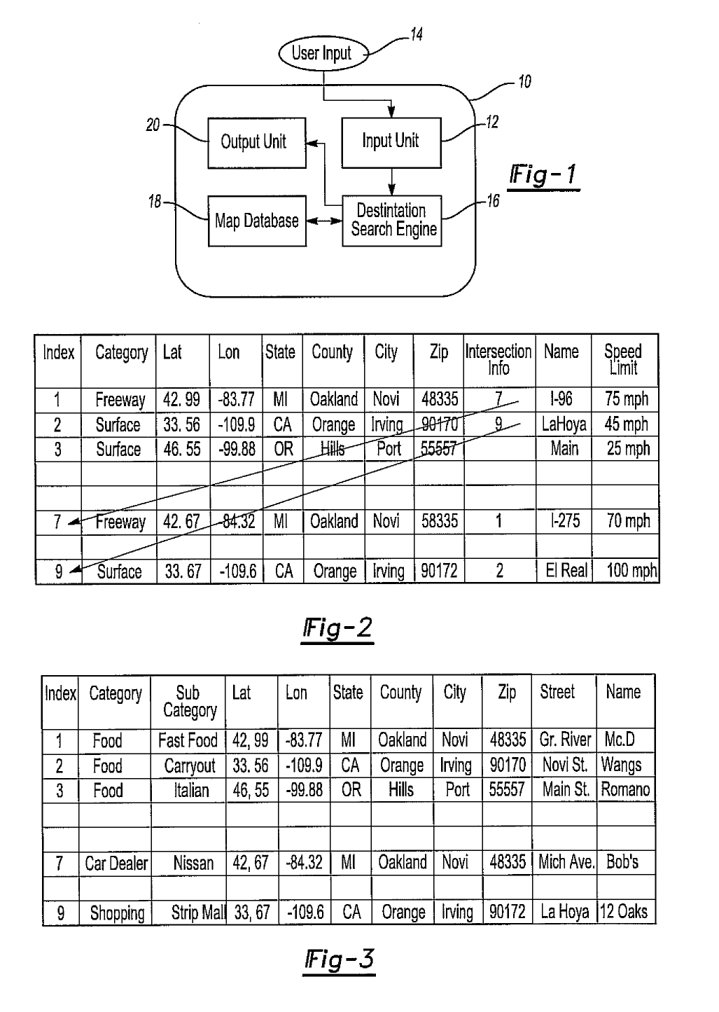

The map database is (FIG. 1) may also contain a point of interest (POI) database. An exemplary POI database is illustrated in FIG. 3. The exemplary database contains a category as well as subcategory entry to identify the type of point of interest in the database. The POI database also contains the location of the database as well as the name of the database.

It will be understood, of course, that the database structures shown in FIGS. 2 and 3 are by way of example only. In practice, the database may contain less or more information. For example, the map database could contain such additional information such as the telephone area code, an address range for a particular road and the like without deviation from either the spirit or scope of the invention.

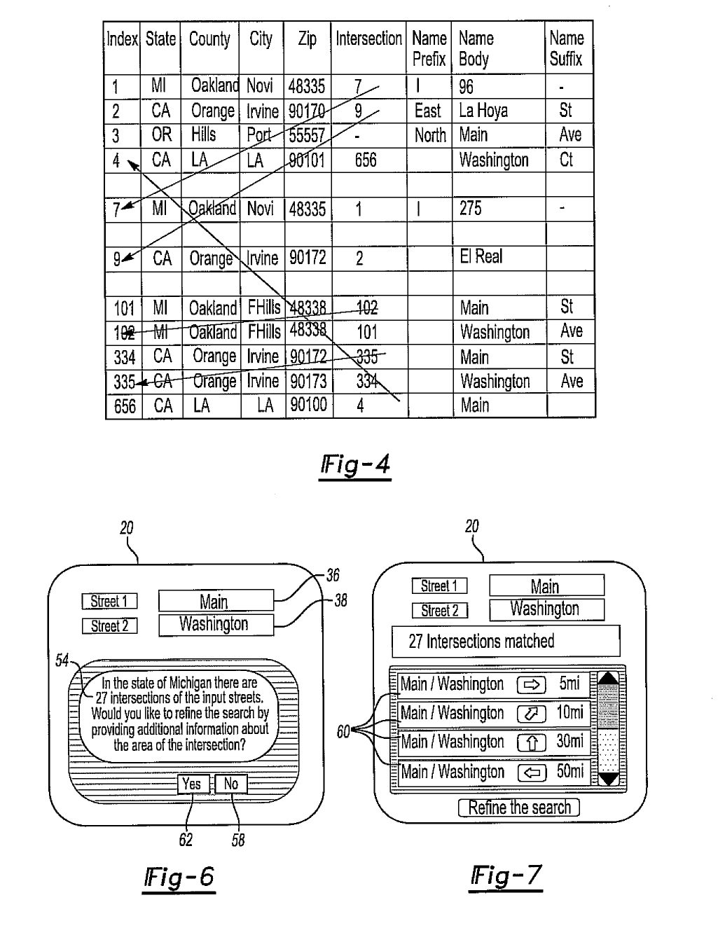

With reference now to FIG. 4, an intersection database illustrated in FIG. 4 containing information only of intersecting roads is preferably contained within either the map database 18, or generated by the destination search engine 16 after a search of the map database and stored in memory separate from the map database. Such an intersection database only contains entries of intersecting roads so that the intersection database illustrated in FIG. 4 is a subdatabase of the overall map database illustrated in FIG. 2.

Although the intersection database illustrated in FIG. 4 may be of any conventional format, as illustrated each road for each intersection is assigned an index number. For each index number, the location, both by state, county, city and postal zip code, is also contained for each entry. The road prefix, e.g. “North”, “West”, etc., is also contained as an entry for each road in the intersection database as well as the name of the body of the road and suffix for that road, e.g. “Street”, “Avenue”, “Road”, etc.

Still referring to FIG. 4, each entry in the intersection table also contains an intersection index information. This intersection info index contains the index number of the intersecting road. For example, route index number 2, i.e. East La Hoya Street in Irvine, Calif., Orange County intersects with index number 9, i.e. El Real in the same city. The provision of the intersection database illustrated in FIG. 4 provides for a much simplified and faster search by intersection.

With reference now to FIG. 5, the present invention provides both a system and method for determining a desired geographic location corresponding to an intersection between two roads. After initialization at step 30, the program proceeds to step 32 where the user inputs a first road name. It is only necessary to input the main body of the road name at step 32 without either the road prefix or suffix. Step 32 then proceeds to step 34.

At step 34, the user inputs the main body of a second road name. As with step 32, the input of the second road name at step 34 may be orally through speech recognition circuitry, or through other input means, such as a GUI using a touch screen for the navigation system.

With reference now to FIG. 6, an exemplary display for the screen 20 is illustrated in which the first street name “Main” is displayed in a first box while the second street name “Washington” is displayed in a second box on the screen 20.

With reference again to FIG. 5, after the roads defining the desired intersection or geographic location have been entered at step 34, step 34 proceeds to step 40. Step 40 then queries the map database 18 to identify all intersections within a predefined geographic area, such as a state, or portion of a state, to determine all intersections which correspond to the roads inputted at steps 32 and 34. It will be understood, of course, that the search engine used at step 40 may be of any conventional construction, such as a relational database search engine, without deviation from the spirit of the invention.

After the database 18 is searched at step 40, step 40 proceeds to step 42 in which a list is generated containing all of the intersections within the predefined geographic area which contain the named intersection. Step 42 then proceeds to step 44.

At step 44, the program determines whether or not the intersection list generated at step 42 contains less than a predetermined threshold number of intersections. If so, step 44 proceeds to step 46 where the list of intersections is displayed on the screen 20 for the user. Step 46 then proceeds to step 48 where the user selects the desired intersection from the list for display on the screen 20 and then exits at step 50.

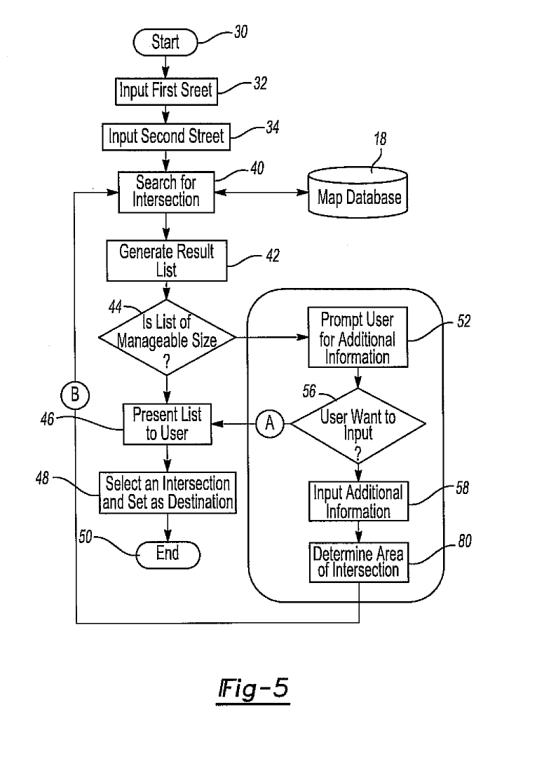

With reference to FIGS. 5 and 6, in the event that the list generated by step 42 contains more than a threshold number of entries, step 44 instead branches to step 52 where the program advises the user of the large number of intersections matching the search in display box 54 and then proceeds to step 56. At step 56, the program queries the user as to whether or not the user desires to input additional information. If not, the user so indicates to the system by any appropriate means, e.g. through voice recognition, by depression of a “No” button 58 on a touch screen (FIG. 6), or the like, whereupon step 56 branches back to step 46 and presents a partial list to the user. One such partial list is illustrated in FIG. 7 and comprises the four entries on the list that are closest to the user. Other types of exemplary displays where the user does not wish to enter additional information may alternatively be used. For example, intersections that have been previously viewed may be first displayed on the screen.

With reference now to FIGS. 5, 6 and 8, if the user desires to enter additional information, the user so indicates by pressing the button 62 on the touch screen 20 (FIG. 6) or other input means, such as through voice recognition. In this event, step 56 branches to step 58 in which the user inputs additional information relating to the desired intersection. For example, as shown in FIG. 8, an exemplary screen is illustrated in which the user is presented with a selection of three different types of additional information. A first type which is selected by selecting the button 64 on the touch screen 20 allows the user to enter a street name near the desired intersection. Similarly, the user may select to enter a point of interest near the desired intersection by touching touch button 66 while the user may specify the city and state by selecting the touch button 68. Likewise, the user may select to enter a direction relative to the vehicle by touching touch button 69 in which case the map database 18 is only searched for matching intersections in the specified direction from the vehicle. Other input means, such as voice recognition, may alternately be used.

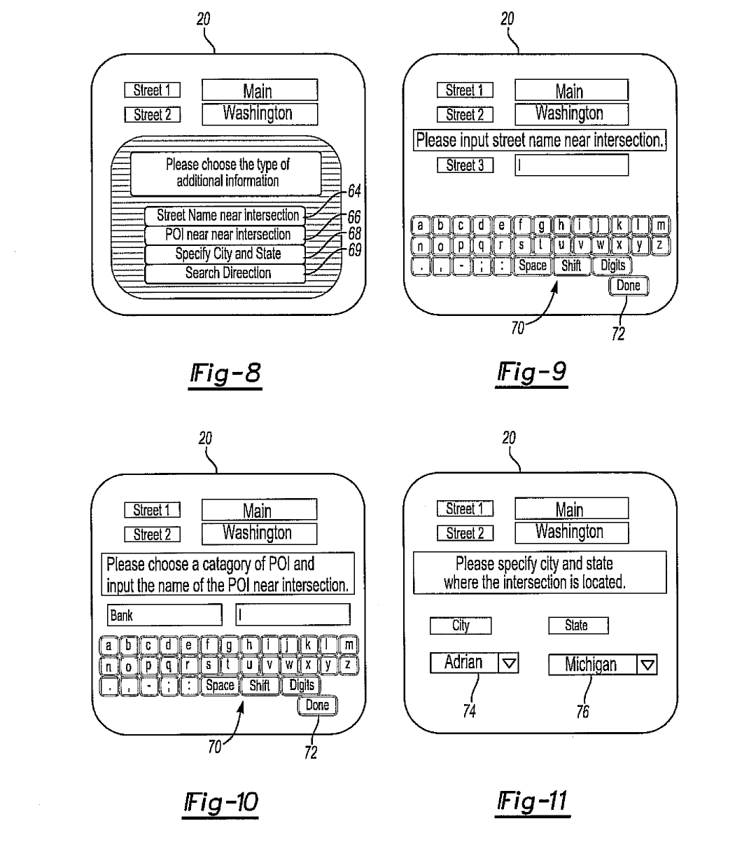

FIG. 9 is an exemplary screen of the GUI showing the screen for the input of a street name near the desired intersection. In this case, a keyboard 70 is displayed on the screen 20 for the entry of the street name. A touch button 72 on the screen 20 enables the user to indicate when the street name is completed.

Similarly, FIG. 10 represents an exemplary screen display which allows the user to enter a point of interest (‘TOr’), such as the name of a golf course, near the desired intersection. As before, a keyboard 70 on the touch screen 20 allows the user to enter in the POI while a touch button 72 allows the user to indicate when the entry has been completed.

Similarly, FIG. 11 is an exemplary screen allowing the user to enter in the city and state name for the desired intersection. Although a keyboard or voice recognition may be used to enter the city and state name, in FIG. 11 the city name is entered through a scroll box 74 while the state is entered through a scroll box 76.

It will be understood, of course, that the display screens illustrated in FIGS. 8-11 which enable the user to input additional information are by way of example only. Other types of information may alternatively be entered by the user in an attempt to identify the desired intersection. For example, the user may enter the telephonic area code, the postal zip code, a range of street addresses, a municipal name, i.e. a city, town, village, etc., and/or the like as additional information.

With reference again to FIG. 5, once the additional information has been entered by the user, step 58 proceeds to step 80 where the area of intersection is determined. Step 80 then proceeds back to step 40 where the map database 18 is again searched for the desired intersection using, however, three items of information, rather than two. The three items of information would comprise the road names corresponding to the desired intersection while the third datum of information would comprise the additional information entered by the user as described above.

Following completion of the search, step 40 proceeds to step 42 which generates the intersection list in which all three criteria are met. Presumably, this list will be much smaller than the previously generated list. Step 42 will then proceed to step 44 where the size of the list will again be examined. In most cases, the list size will be less than the threshold amount required at step 44 so that step 44 will proceed to step 46 and display the list to the user. Alternatively, step 44 will branch to step 52 and allow the user to input another type of information in order to further narrow the list.

Although in the preferred embodiment of the invention, upon entry of the additional information at step 58 (FIG. 5), the map database 18 is again searched by using three search criteria rather than two, alternatively only the list generated at 42 is searched using the information inputted by the user at step 58. Such a limited search of only the generated list as opposed to the entire map database 18 both simplifies as well as speeds the execution of the program.

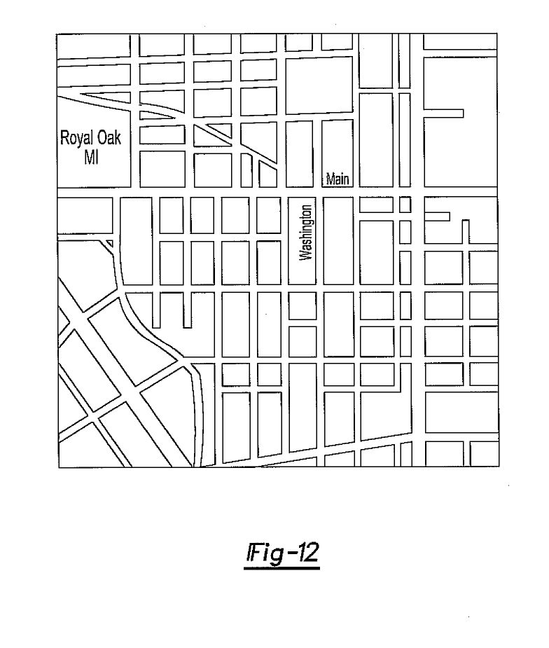

Once the desired intersection has been identified, a map of the intersection is displayed on the display device 20 as shown in FIG. 12.

From the foregoing, it can be seen that the present invention provides a simple and yet effective method and system for identifying a desired intersection corresponding to the desired geographic location where there are several intersections having the same body for the road names of the intersection. Having described our invention, however, many modifications thereto will become apparent to those skilled in the art to which it pertains without deviation from the spirit of the invention as defined by the scope of the appended claims.

We claim:

1. For use in conjunction with a navigation system, a method for determining a desired geographic location comprising the steps of:
receiving at least two road names corresponding to an intersection,
identifying all intersections within a geographic area which correspond to the received road names,
in the event that the number of identified intersections exceed a preset threshold, receiving additional information regarding the desired geographic location and thereafter searching the identified intersections to determine the desired geographic location by utilizing the additional information,
thereafter communicating the results of the search to a user.

2. The invention as defined in claim 1 wherein said additional information is selected from the group consisting of a municipal name, a point of interest, a telephone area code, a postal zip code, a road name, direction and a road address range.

3. The invention as defined in claim 1 wherein said additional information inputting step comprises the step of inputting said additional information vocally.

4. The invention as defined in claim 1 wherein said additional information inputting step comprises the step of inputting said additional information by a keyboard.

5. The invention as defined in claim 4 wherein the navigation system comprises a display screen and wherein said additional information inputting step comprises the step of displaying said keyboard on the display screen.

6. The invention as defined in claim 1 wherein the navigation system comprises a display screen and wherein said additional information inputting step comprises the step of inputting said additional information through a graphic user interface on the display screen.

7. The invention as defined in claim 1 wherein said communicating step comprises the step of displaying the results of the search as a map on a display screen.

8. A navigation system comprising:
a display screen,
means for inputting two road names representing an intersection at a desired geographic location,
means for identifying all intersections within a geographic area which correspond to the inputted intersection,
means for inputting additional information regarding the desired geographic location whenever the number of identified intersections exceed a preset threshold,
means for thereafter searching the identified intersections to determine the desired geographic location by utilizing said additional information, and
means for communicating the results of said search to a user.

9. The invention as defined in claim 8 wherein said means for inputting additional information comprises the means for inputting additional information selected from the group consisting of a municipal name, a point of interest, a telephone area code, a postal zip code, a road name, direction and a road address range.

10. The invention as defined in claim 8 wherein said means for inputting additional information comprises the means for inputting said additional information vocally through speech recognition means.

11. The invention as defined in claim 8 wherein said means for inputting additional information comprises the means for inputting said additional information through a graphic user interface displayed on said screen.

12. The invention as defined in claim 11 wherein said graphic user interface comprises a keyboard displayed on said display screen.

13. The invention as defined in claim 8 wherein said navigation system is contained within an automotive vehicle.

14. The invention as defined in claim 8 wherein said communicating means comprises means for displaying the desired geographic location by displaying a map of the desired geographic location on said display screen.

15. A navigation system comprising:
a display screen,
an input device to enter two road names representing an intersection at a desired geographic location,
a map database containing road geographic information,
a search engine which queries said map database and identifies all intersections within a geographic area which correspond to the inputted intersection,
said input device inputting additional information regarding the desired geographic location whenever the number of intersections identified by said search engine exceed a preset threshold, and
said search engine being programmed to query said map database utilizing the additional information to determine the desired geographic location,
displaying a map on said display screen of the desired geographic location.

16. The invention as defined in claim 15 wherein said additional information is selected from the group consisting of a municipal name, a postal zip code, a telephone area code, a road address range, a road name and a point of interest.

17. The invention as defined in claim 15 wherein said input device comprises a speech recognition system.

18. The invention as defined in claim 15 wherein said screen is a touch screen, and wherein said input device comprises a keyboard displayed on said screen.

19. The invention as defined in claim 15 wherein said navigation system is contained within an automotive vehicle.
